(19) United States
(12) Patent Application Publication
(10) Pub. No.: US 2024/0218929 A1
(43) Pub. Date: Jul. 4, 2024

(54) SEAL FOR A PORT OF AN ENCLOSURE CONFIGURED TO PERMIT A PRE-CONNECTORIZED CABLE TO BE INSERTED INTO AND REMOVED FROM THE SEAL WITH A CONNECTOR ATTACHED TO THE CABLE

(71) Applicant: PPC BROADBAND, INC., East Syracuse, NY (US)

(72) Inventor: Nicholas LARSSON, Blomkest, MN (US)

(73) Assignee: PPC BROADBAND, INC., East Syracuse, NY (US)

(21) Appl. No.: 18/401,491

(22) Filed: Dec. 31, 2023

Related U.S. Application Data
(60) Provisional application No. 63/436,567, filed on Dec. 31, 2022.

(51) Int. Cl. F16J 15/10; G02B 6/44

(52) U.S. Cl. CPC F16J 15/104; G02B 6/4444

(57) ABSTRACT

A seal for a port of an enclosure may include a sealing portion structurally configured to be received in a port and a support portion structurally configured to be received by the sealing portion such that the support portion covers a portion of the sealing portion so as to prevent a pre-connectorized cable from being inserted into and removed from the sealing portion. The support portion may be structurally configured to be removed from the sealing portion so as to permit a pre-connectorized cable to be inserted into or removed from the sealing portion with a connector attached to the cable.

### CROSS-REFERENCE TO RELATED APPLICATION

This application claims the benefit of U.S. Provisional Application No. 63/436,567, filed Dec. 31, 2022, the disclosure of which is hereby incorporated by reference herein in its entirety.

### BACKGROUND

Some conventional sealing ports of cable enclosure boxes have a round opening through which a non-terminated cable end can be inserted and sealed via an interference fit between the seal and the cable. Then, after the cable end is inserted into the box, the cable end is terminated with a connector that is larger than the opening through the seal. Thus, in order to remove the cable from the box, the connector has to be removed usually by cutting the cable. The cable must then be terminated with a new connector after being reinserted into the enclosure box. All of this wastes the technician user's time and the cost of multiple connectors.

Some conventional enclosure boxes, for example, fiber terminals, include closed cell foam grommet systems to provide lay-in cable sealing solutions. A lay-in solution refers to the ability to install pre-connectorized fiber cables without passing the connector end through the sealing surfaces. These lay-in slits in the foam grommet allow the mid-span of a cable to slide into the sealing positions and typically span a large portion of the overall grommet size, generally down the center of the grommet normal to the direction in which the grommet is compressed. While this arrangement allows for quick and easy installation of fiber cables it can be challenging to maintain a good seal. A soft or low durometer foam is best for forming a seal around the inserted cables. However, with a large slit through the center of the grommet, a soft material will not maintain its shape when cables are installed causing voids in the seal.

Accordingly, it may be desirable to provide a sealing member for a port of an enclosure that permits a pre-connectorized cable to be inserted into and removed from the port of the enclosure. It may also be desirable to provide a sealing member with improved cable capacity. It may also be desirable to provide a sealing member configured to maintain sealing consistency.

### SUMMARY

In an exemplary aspect of the disclosure, a seal for a port of an enclosure may include a sealing portion configured to be received in a seal receiving portion of a port, and a support portion configured to be received in the seal receiving portion. The sealing portion may comprise a resilient member, and the sealing portion may be configured to include a cable receiving portion that is structurally configured to receive a portion of a pre-connectorized cable. The sealing portion may be configured to include a cable holding portion extending from the cable receiving portion, and the cable holding portion may be structurally configured to hold a cable received by the cable receiving portion. The support portion may include an engagement portion and elongated support portions that extend from the engagement portion in a first direction, and the elongated support portions may be spaced apart from one another by a distance that is less than or equal to a thickness of the sealing portion. The support portion may be configured to be received by the sealing portion such that the engagement portion engages a top surface portion of the sealing portion so as to compress the sealing portion in the first direction, thereby enhancing sealing by the sealing portion. Each of the elongated support portions may include a free end portion that is configured to be received in the seal receiving portion so as to maintain the distance between the elongated support portions such that the elongated support portions support a portion of the sealing portion in a direction of the thickness of the sealing portion, thereby enhancing sealing by the sealing portion. The support portion may be structurally configured to cover a portion of the cable receiving portion so as to enhance sealing by the sealing portion and to prevent a cable from being removed from the sealing portion via the cable receiving portion, and the cable holding portion maybe structurally configured to prevent a pre-connectorized cable from being inserted into and removed from the cable holding portion when the support portion is received by the sealing portion. The support portion may be configured to be removed from the sealing portion so as to permit a pre-connectorized cable to be inserted into or removed from the cable holding portion with a connector attached to the cable.

In some embodiments of the seal, the cable receiving portion may comprise a slit that extends from a first end of the seal portion to a portion of the seal portion spaced from a second end.

In some embodiments of the seal, the cable holding portion may comprise a slit that extends from the cable receiving portion in a direction that slopes away from the first end.

In some aspects, a port portion configured to provide access to an enclosure may include the seal of one of the aforementioned embodiments and a seal receiving portion structurally configured to receive the seal so as to seal an opening to an enclosure.

In some embodiments, the port portion may be configured to be removed from the enclosure.

According to another exemplary aspect of the disclosure, a seal for a port of an enclosure may include a sealing portion configured to be received in a port, and a support portion configured to be received by the sealing portion. The sealing portion may be configured to include a cable receiving portion that is structurally configured to receive a portion of a pre-connectorized cable, and the support portion may be structurally configured to cover a portion of the cable receiving portion so as to enhance sealing by the sealing portion and to prevent a cable from being removed from the sealing portion via the cable receiving portion. The support portion may be configured to be removed from the sealing portion so as to permit a pre-connectorized cable to be inserted into or removed from the cable holding portion with a connector attached to the cable.

In some embodiments of the seal, the sealing portion may be configured to include a cable holding portion extending from the cable receiving portion.

In some embodiments of the seal, the cable holding portion may be structurally configured to hold a cable received by the cable receiving portion.

In some embodiments of the seal, the cable receiving portion may comprise a slit that extends from a first end of the seal portion to a portion of the seal portion spaced from a second end.

In some embodiments of the seal, the cable holding portion may comprise a slit that extends from the cable receiving portion in a direction that slopes away from the first end.

In some embodiments of the seal, the cable holding portion may be structurally configured to prevent a pre-connectorized cable from being inserted through and removed from the cable holding portion when the support portion is received by the sealing portion.

In some embodiments of the seal, the support portion may include an engagement portion and elongated support portions that extend from the engagement portion in a first direction;

In some embodiments of the seal, the elongated support portions may be spaced apart from one another by a distance that is less than or equal to a thickness of the sealing portion.

In some embodiments of the seal, each of the elongated support portions may include a free end portion that is configured to be received in a seal receiving portion so as to maintain the distance between the elongated support portions such that the elongated support portions support a portion of the sealing portion in a direction of the thickness of the sealing portion, thereby enhancing sealing by the sealing portion.

In some embodiments of the seal, the support portion may include an engagement portion that is structurally configured to engage an end surface of the sealing portion so as to compress the sealing portion, thereby enhancing sealing by the sealing portion.

In some embodiments of the seal, the support portion may be structurally configured to compress the sealing portion in a thickness direction of the sealing portion.

In some aspects, a port portion configured to provide access to an enclosure may include the seal of one of the aforementioned embodiments and a seal receiving portion structurally configured to receive the seal so as to seal an opening to an enclosure.

In some embodiments, the port portion may be configured to be removed from the enclosure.

In another exemplary aspect of the disclosure, a seal for a port of an enclosure may include a sealing portion configured to be received in a port and a support portion configured to be received by the sealing portion such that the support portion covers a portion of the sealing portion so as to prevent a pre-connectorized cable from being inserted into and removed from the sealing portion. The support portion may be configured to be removed from the sealing portion so as to permit a pre-connectorized cable to be inserted into or removed from the sealing portion with a connector attached to the cable.

In some embodiments of the seal, the sealing portion may include a cable receiving portion that is structurally configured to receive a portion of a pre-connectorized cable.

In some embodiments of the seal, the sealing portion may include a cable holding portion extending from the cable receiving portion.

In some embodiments of the seal, the cable holding portion may be structurally configured to hold a cable received by the cable receiving portion.

In some embodiments of the seal, the cable receiving portion may comprise a slit that extends from a first end of the seal portion to a portion of the seal portion spaced from a second end.

In some embodiments of the seal, the cable holding portion may comprise a slit that extend from the cable receiving portion in a direction that slopes away from the first end.

In some embodiments of the seal, the cable holding portion may be structurally configured to prevent a pre-connectorized cable from being inserted through and removed from the cable holding portion when the support portion is received by the sealing portion.

In some embodiments of the seal, the support portion may include an engagement portion and elongated support portions that extend from the engagement portion in a first direction.

In some embodiments of the seal, the elongated support portions may be spaced apart from one another by a distance that is less than or equal to a thickness of the sealing portion.

In some embodiments of the seal, each of the elongated support portions may include a free end portion that is configured to be received in a seal receiving portion so as to maintain the distance between the elongated support portions such that the elongated support portions support a portion of the sealing portion in a direction of the thickness of the sealing portion, thereby enhancing sealing by the sealing portion.

In some embodiments of the seal, the support portion may include an engagement portion that is structurally configured to engage an end surface of the sealing portion so as to compress the sealing portion, thereby enhancing sealing by the sealing portion.

In some embodiments of the seal, the support portion may be structurally configured to compress the sealing portion in a thickness direction of the sealing portion.

In some aspects, a port portion configured to provide access to an enclosure may include the seal of one of the aforementioned embodiments and a seal receiving portion structurally configured to receive the seal so as to seal an opening to an enclosure.

In some embodiments, the port portion may be configured to be removed from the enclosure.

Various aspects of the seal assembly, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective view of a portion of an exemplary enclosure box that comprises a seal assembly having a sealing member receiving area with a corresponding interference fit structure in an open position in accordance with various aspects of the disclosure.

FIG. 1 is a perspective view of a fiber enclosure including an exemplary seal assembly in accordance with various aspects of the disclosure.

FIG. 2 is an enlarged perspective view of the seal assembly of FIG. 1.

FIG. 3 is an enlarged perspective view of the seal assembly of FIG. 1.

FIG. 4 is a perspective view of another exemplary seal assembly in accordance with various aspects of the disclosure.

### DETAILED DESCRIPTION OF EMBODIMENTS

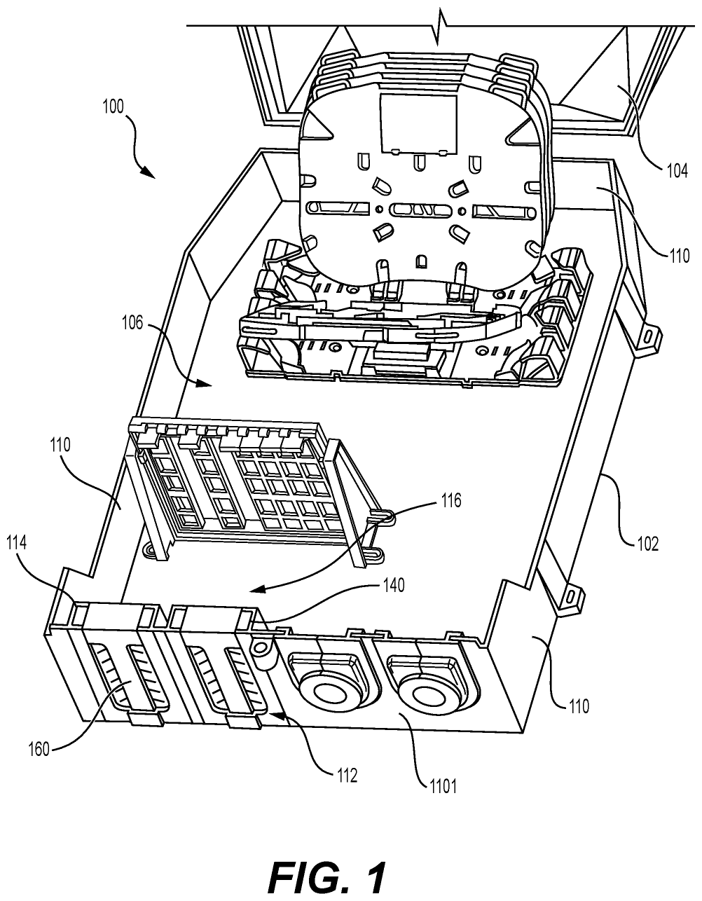

FIG. 1 illustrates an enclosure 100 that includes a base portion 102 defining a cavity and a cover portion 104 configured to be coupled with the base portion 102 to close the enclosure. In some aspects, the base portion 102 and the cover portion 104 may be configured to provide a sealed interface therebetween. The enclosure may include one or more electrical components, for example, fiber optic components 106 in the base portion 102. The base portion 102 may include a wall portion, for example, a plurality of walls 110, 1101, and a port portion 112 configured to permit a cable, for example, an optical fiber cable, to pass through the wall portion into an interior of the base portion 102. In some aspects, the port portion 112 may be structurally configured to be coupled, removably or non-removably, with the wall portion. In some aspects, the port portion 112 may be monolithically formed with the wall portion as a single piece. Although illustrated and described as a fiber enclosure, the enclosure may be any type of enclosure having a port for receiving a call.

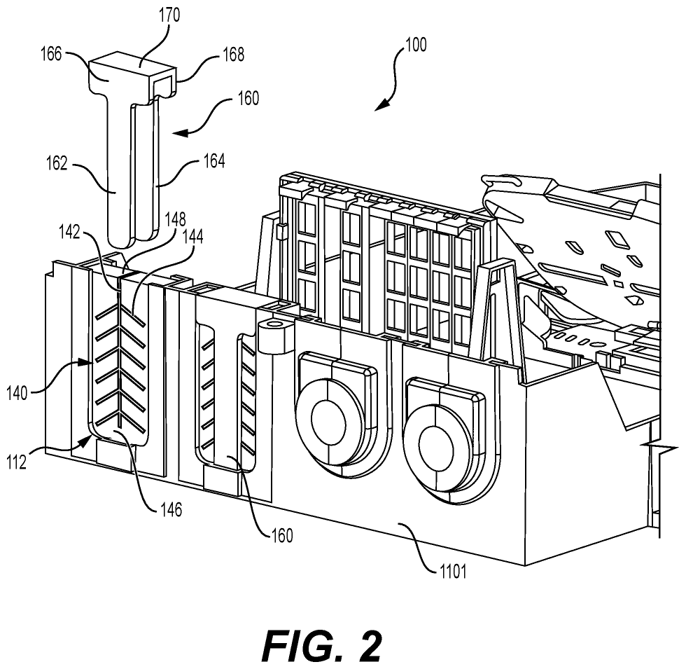

FIGS. 1-3 illustrate an exemplary seal 116 structurally configured to seal the port portion 112 of the enclosure 100 in accordance with various aspects of the disclosure. The port portion 112 includes a seal receiving portion 114, and the seal 116 includes a sealing portion 140 and a support portion 160 that are structurally configured to seal the port portion 112.

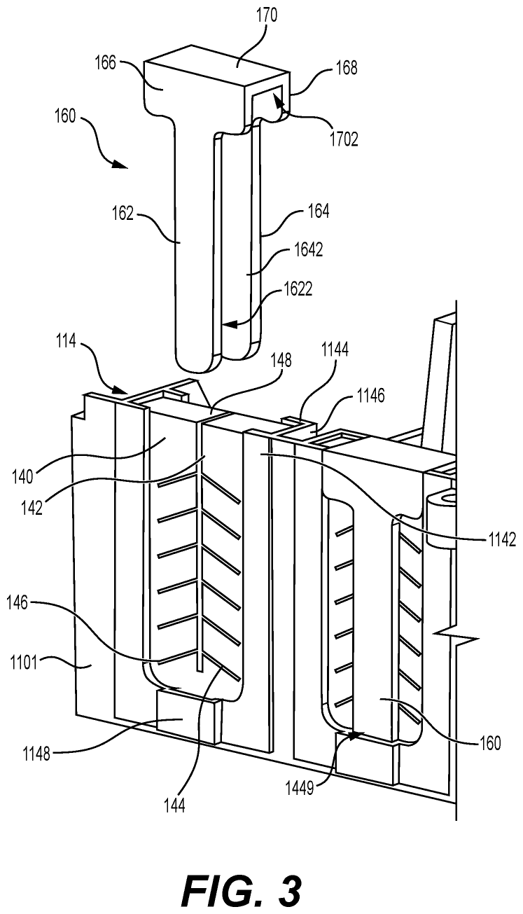

In the illustrated embodiment, the seal receiving portion 114 comprises a pair of spaced apart U-shaped channels 115, wherein each channel is delimited by a first wall portion 1142, a second wall portion 1144, and a third wall portion 1146. The first and second wall portions 1142, 1144 are parallel to one another, and the third wall portion 1146 connects the first and second wall portions 1142 to form the U-shaped channels. As best shown in FIG. 3, the seal receiving portion 114 includes an opening portion 117 defined between the U-shaped channels 115. In some aspects, the first wall portion 1142 may be an integral part of the wall 1101.

In some aspects, the sealing portion 140 may comprise a grommet, for example, a closed cell foam grommet. As would be understood by persons skilled in the art, the foam grommet may comprise a soft or low durometer foam that is structurally configured to form a seal around a cable extending through the grommet. The sealing portion 140 includes cable receiving portion 142, for example, an elongated slit or cut, extending from an end wall 148 of the sealing portion 140 toward an opposite end. As illustrated, the cable receiving portion 142 may extend for a portion of a length of the sealing portion 140. The sealing portion 140 include a cable holding portion 144, 146, for example, one or more slits or cuts, extending from the cable receiving portion 142 for a portion of the distance to a side edge of the first insert portion that extends parallel to the cable receiving portion 142. The cable holding portion 144, 146 extends away from the elongated slit 142 in a direction that slopes away from the end wall 148. In some aspects, the sealing portion 140 may include a first cable holding portion 144, for example, a slit or cut, that extends from one side of the cable receiving portion 142 and a second cable holding portion 146, for example, a slit or cut, that extends from an opposite side of the elongated slit 142. In some aspects, the sealing portion 140 may include a plurality of first cable holding portions 144 and/or a plurality of second cable holding portions 146.

The support portion 160, for example, a bracket, may comprise a T-shape having two elongated support portions 162, 164 and two shorter support portions 166, 168 that extend perpendicular to the elongated support portions 162, 164. The two shorter support portions 166, 168 extend perpendicular to the two elongated support portions 162, 164. The two shorter support portions 166, 168 have a length that substantially matches the distance between the two U-shaped channels of the seal receiving portion 114. The two shorter support portions 166, 168 are connected by a transverse portion 170. The two elongated support portions 162, 164 are spaced apart from one other by a distance, and the two shorter support portions 166, 168 are spaced apart from one other by the same distance. The distance between the two elongated support portions 162, 164 and between the two shorter support portions 166, 168 is determined by the dimension of the transverse portion that extends between the shorter support portions 166, 168. The first elongated support portion 162 and the first shorter support portion 166 define a first inner surface portion 1622, and the second elongated support portion 164 and the second shorter support portion 168 define a second inner surface portion 1624. The transverse portion 170 includes an engagement portion 1702, for example, an inner surface portion, that faces in a direction in which the elongated support portions 162, 164 extend.

In use, the sealing portion 140 is inserted into an open end of the seal receiving portion 114. The sealing portion 140 may comprise a compressible material, for example, a closed cell foam, such that a thickness of the sealing portion 140 may be greater than the width of the U-shaped channel between the first wall portion 1142 and the second wall portion 1144 such that the sealing portion 140 is compressed between the first wall portion 1142 and the second wall portion 1144. A cable, for example, a pre-connectorized fiber cable, is inserted into the cable receiving portion 142 and into a portion of the cable holding portion 144, 146. The support portion 160 is then inserted into the seal receiving portion 114 until the shorter support portions 166, 168 are between the first wall portions 1142 and the second wall portions 1144, respectively, of the seal receiving portion 114 and a free end portion, for example, free ends 1621, 1641 of the elongated arms 162, 164 are received in a notch 1148 at a bottom portion of the seal receiving portion 114. In some aspects, the support portion 160 may be inserted into the seal receiving portion 114 until the inner surface portion 1702 of the transverse portion 170 engages the end wall 148 of the sealing portion 140.

The support portion 160 is structurally configured such that, after insertion into the seal receiving portion 114, the support portion compresses the sealing portion 140 in two directions. For example, the inner surface portion 1702 of the transverse portion 170 engages the end wall 148 of the sealing portion 140 to compress the sealing portion 140 in the insertion direction. and the two inner surface portions 1622, 1642 of the second insert portion 164 compress the sealing portion 140 towards one another when the free ends 1621, 1641 of the elongated arms 162, 164 are received in the notch 1148 of the seal receiving portion 114.

To remove the cable from the seal 116, the support portion 160 is removed, and the cable is slid out from the cable holding portion 144, 146 into the cable receiving portion 152 and then out of the cable receiving portion 152. The procedure of inserting and removing the cable can be repeated as often as needed. As a result, a pre-connectorized cable, for example, a pre-connectorized fiber cable, can be inserted into and removed from the seal assembly as often as desired without the need for removing the connector from the cable.

It should be understood that when a fiber cable is inserted into the cable holding portion, the fiber cable does not impede placement of the holding portion 160 between the first wall portions 1142 and the second wall portions 1144 of the receiving portion 114.

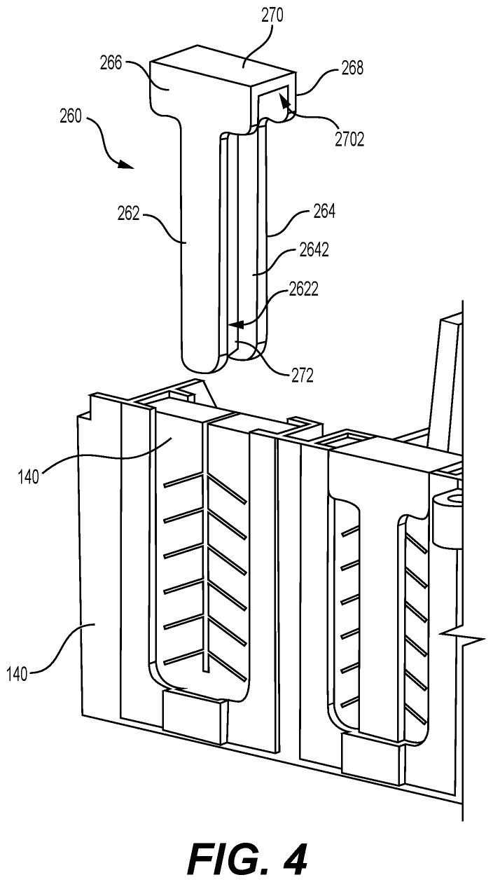

Referring now to FIG. 4, another exemplary seal assembly is illustrated. The seal assembly is similar to the previously described seal assembly, but the second insert portion includes a second transverse portion 272 extending between the first elongated support portion 262 and the second elongated support portion 264 from the transverse portion 270 along a length of the first and second elongated support portions 262, 264.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A seal for a port of an enclosure configured to permit a pre-connectorized cable to be inserted into and removed from the port with a connector attached to the cable, comprising:
a sealing portion configured to be received in a seal receiving portion of a port;
a support portion configured to be received in the seal receiving portion;
wherein the sealing portion comprises a resilient member;
wherein the sealing portion is configured to include a cable receiving portion that is structurally configured to receive a portion of a pre-connectorized cable;
wherein the sealing portion is configured to include a cable holding portion extending from the cable receiving portion;
wherein the cable holding portion is structurally configured to hold a cable received by the cable receiving portion;
wherein the support portion is configured to include an engagement portion and elongated support portions that extend from the engagement portion in a first direction;
wherein the elongated support portions are spaced apart from one another by a distance that is less than or equal to a thickness of the sealing portion;
wherein the support portion is configured to be received by the sealing portion such that the engagement portion engages a top surface portion of the sealing portion so as to compress the sealing portion in the first direction, thereby enhancing sealing by the sealing portion;
wherein each of the elongated support portions includes a free end portion that is configured to be received in the seal receiving portion so as to maintain the distance between the elongated support portions such that the elongated support portions support a portion of the sealing portion in a direction of the thickness of the sealing portion, thereby enhancing sealing by the sealing portion;
wherein the support portion is structurally configured to cover a portion of the cable receiving portion so as to enhance sealing by the sealing portion and to prevent a cable from being removed from the sealing portion via the cable receiving portion;
wherein the cable holding portion is structurally configured to prevent a pre-connectorized cable from being inserted into and removed from the cable holding portion when the support portion is received by the sealing portion; and
wherein the support portion is structurally configured to be removed from the sealing portion so as to permit a pre-connectorized cable to be inserted into or removed from the cable holding portion with a connector attached to the cable.

2. The seal of claim 1, wherein the cable receiving portion comprises a slit that extends from a first end of the seal portion to a portion of the seal portion spaced from a second end; and
wherein the cable holding portion comprises a slit that extends from the cable receiving portion in a direction that slopes away from the first end.

3. A port portion configured to provide access to an enclosure, comprising:
the seal of claim 1;
a seal receiving portion structurally configured to receive the seal so as to seal an opening to an enclosure.

4. The port portion of claim 3, wherein the port portion is configured to be removed from the enclosure.

5. A seal for a port of an enclosure configured to permit a pre-connectorized cable to be inserted into and removed from the seal with a connector attached to the cable, comprising:
a sealing portion configured to be received in a port;
a support portion configured to be received by the sealing portion;
wherein the sealing portion is configured to include a cable receiving portion that is structurally configured to receive a portion of a pre-connectorized cable;
wherein the support portion is structurally configured to cover a portion of the cable receiving portion so as to enhance sealing by the sealing portion and to prevent a cable from being removed from the sealing portion via the cable receiving portion; and
wherein the support portion is configured to be removed from the sealing portion so as to permit a pre-connectorized cable to be inserted into or removed from the cable holding portion with a connector attached to the cable.

6. The seal of claim 5, wherein the sealing portion is configured to include a cable holding portion extending from the cable receiving portion; and
wherein the cable holding portion is structurally configured to hold a cable received by the cable receiving portion.

7. The seal of claim 6, wherein the cable receiving portion comprises a slit that extends from a first end of the seal portion to a portion of the seal portion spaced from a second end; and
wherein the cable holding portion comprises a slit that extends from the cable receiving portion in a direction that slopes away from the first end.

8. The seal of claim 6, wherein the cable holding portion is structurally configured to prevent a pre-connectorized cable from being inserted through and removed from the cable holding portion when the support portion is received by the sealing portion.

9. The seal of claim 5, wherein the support portion includes an engagement portion and elongated support portions that extend from the engagement portion in a first direction; and
wherein the elongated support portions are spaced apart from one another by a distance that is less than or equal to a thickness of the sealing portion.

10. The seal of claim 9, wherein each of the elongated support portions includes a free end portion that is configured to be received in a seal receiving portion so as to maintain the distance between the elongated support portions such that the elongated support portions support a portion of the sealing portion in a direction of the thickness of the sealing portion, thereby enhancing sealing by the sealing portion.

11. The seal of claim 5, wherein the support portion includes an engagement portion that is structurally configured to engage an end surface of the sealing portion so as to compress the sealing portion, thereby enhancing sealing by the sealing portion.

12. The seal of claim 5, wherein the support portion is structurally configured to compress the sealing portion in a thickness direction of the sealing portion.

13. A port portion configured to provide access to an enclosure, comprising:
the seal of claim 5;
a seal receiving portion structurally configured to receive the seal so as to seal an opening to an enclosure.

14. The port portion of claim 13, wherein the port portion is configured to be removed from the enclosure.

15. A seal for a port of an enclosure configured to permit a pre-connectorized cable to be inserted into and removed from the seal with a connector attached to the cable, comprising:
a sealing portion configured to be received in a port;
a support portion configured to be received by the sealing portion such that the support portion covers a portion of the sealing portion so as to prevent a pre-connectorized cable from being inserted into and removed from the sealing portion; and
wherein the support portion is configured to be removed from the sealing portion so as to permit a pre-connectorized cable to be inserted into or removed from the sealing portion with a connector attached to the cable.

16. The seal of claim 15, wherein the sealing portion includes a cable receiving portion that is structurally configured to receive a portion of a pre-connectorized cable.

17. The seal of claim 16, wherein the sealing portion includes a cable holding portion extending from the cable receiving portion; and
wherein the cable holding portion is structurally configured to hold a cable received by the cable receiving portion.

18. The seal of claim 17, wherein the cable receiving portion comprises a slit that extends from a first end of the seal portion to a portion of the seal portion spaced from a second end; and
wherein the cable holding portion comprises a slit that extend from the cable receiving portion in a direction that slopes away from the first end.

19. The seal of claim 17, wherein the cable holding portion is structurally configured to prevent a pre-connectorized cable from being inserted through and removed from the cable holding portion when the support portion is received by the sealing portion.

20. The seal of claim 15, wherein the support portion includes an engagement portion and elongated support portions that extend from the engagement portion in a first direction; and
wherein the elongated support portions are spaced apart from one another by a distance that is less than or equal to a thickness of the sealing portion.

21. The seal of claim 20, wherein each of the elongated support portions includes a free end portion that is configured to be received in a seal receiving portion so as to maintain the distance between the elongated support portions such that the elongated support portions support a portion of the sealing portion in a direction of the thickness of the sealing portion, thereby enhancing sealing by the sealing portion.

22. The seal of claim 15, wherein the support portion includes an engagement portion that is structurally configured to engage an end surface of the sealing portion so as to compress the sealing portion, thereby enhancing sealing by the sealing portion.

23. The seal of claim 15, wherein the support portion is structurally configured to compress the sealing portion in a thickness direction of the sealing portion.

24. A port portion configured to provide access to an enclosure, comprising:
the seal of claim 15;
a seal receiving portion structurally configured to receive the seal so as to seal an opening to an enclosure.

25. The port portion of claim 24, wherein the port portion is configured to be removed from the enclosure.
